(19) United States
(12) Patent Application Publication
(10) Pub. No.: US 2010/0188528 A1
(43) Pub. Date: Jul. 29, 2010

(54) IMAGE RECORDING DEVICE, MANUFACTURING APPARATUS OF IMAGE RECORDING DEVICE, AND MANUFACTURING METHOD OF IMAGE RECORDING DEVICE

(75) Inventors: Katsuo IWATA, Kanagawa (JP); Takayuki OGASAHARA, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/693,732

(22) Filed: Jan. 26, 2010

(30) Foreign Application Priority Data
Jan. 28, 2009 (JP) 2009-017045
Jan. 28, 2009 (JP) 2009-017046

(51) Int. Cl. H04N 5/76; B23P 17/00

(52) U.S. Cl. 348/231.99; 29/592.1

(57) ABSTRACT

An image recording device that records captured image data according to an embodiment of the present invention includes: an image sensor that acquires image data; a memory that holds measured PSF data indicating a PSF of at least one area of the image sensor virtually divided into a plurality of areas; and a restoring unit that restores the image data by using the measured PSF data. The measured PSF data is acquired from captured data acquired by capturing an adjustment chart for virtually dividing the image sensor into a plurality of areas by the image recording device.

### CROSS-REFERENCE TO RELATED APPLICATIONS

This application is based upon and claims the benefit of priority from the prior Japanese Patent Application No. 2009-017045, filed on Jan. 28, 2009, and the prior Japanese Patent Application No. 2009-017046, filed on Jan. 28, 2009; the entire contents of which are incorporated herein by reference.

### BACKGROUND OF THE INVENTION

1. Field of the Invention

The present invention relates to an image recording device, a manufacturing apparatus of an image recording device, and a manufacturing method of an image recording device.

2. Description of the Related Art

Conventionally, a camera module as an image recording device used for a digital camera and the like that converts an image of a captured subject to image data and electronically stores the image therein has been known. The image quality of images captured by such an image recording device degrades due to occurrence of density distortion, geometrical distortion, or blur, due mainly to optical aberrations. Generally, edge enhancement filtering is performed to reduce unnecessary information and to extract useful information from the degraded images. Further, there is an image restoration technique as a technique for acquiring highly accurate images. There are various types of the image restoration technique, and for example, a restoring process using a point spread function (PSF), which is an optical transfer function, is proposed in Japanese Patent Application Laid-Open No. 2007-183842.

However, there is a problem that, although it is possible to calculate the PSF with respect to a design value of a lens used for an image recording device, restoration of the optical distortion due to a lens manufacturing error and an error at the time of assembling the image recording device is difficult. In the present application, the difference for each image recording device generated due to a lens manufacturing error and an error at the time of assembling the image recording device is referred to as “individual difference”.

Conventionally, to improve the quality of image data acquired by an image recording device, high accuracy has been required at the time of manufacturing lenses and assembling image recording devices. Therefore, there is another problem that the cost of parts and assembly processes are increased. Further, the requirement of high accuracy at the time of manufacturing lenses and assembling image recording devices causes a decrease in yield, thereby incurring a further cost increase.

### BRIEF SUMMARY OF THE INVENTION

An image recording device according to an embodiment of the present invention comprises: An image recording device that records captured image data, the image recording device comprising: an image sensor that converts light from a subject to a signal charge to acquire the image data;a memory that holds measured PSF data indicating a PSF of at least one area of the image sensor virtually divided into a plurality of areas; and a restoring unit that restores the image data by using the measured PSF data, wherein the measured PSF data is acquired from captured data acquired by capturing an adjustment chart for virtually dividing the image sensor into a plurality of areas by the image recording device.

A manufacturing apparatus of an image recording device according to an embodiment of the present invention comprises: a manufacturing apparatus of an image recording device comprising: a capturing unit that causes an image recording device to capture an adjustment chart for virtually dividing an image sensor provided in the image recording device into a plurality of areas; and an input unit that inputs measured PSF data indicating a PSF of the areas acquired from captured data of the adjustment chart captured by the image recording device to a memory provided in the image recording device so that the measured PSF data is held therein.

A manufacturing method of an image recording device according to an embodiment of the present invention comprises: a manufacturing method of an image recording device comprising an imaging lens that takes light from a subject and an image sensor that converts light from the subject to a signal charge to acquire image data, the manufacturing method comprising: assembling the image recording device by adjusting a distance between the imaging lens and the image sensor; causing the image recording device to capture an adjustment chart for virtually dividing the image sensor into a plurality of areas; and holding including inputting measured PSF data indicating a PSF of the areas acquired from captured data of the adjustment chart captured by the image recording device to a memory provided in the image recording device, and holding the measured PSF data therein.

### BRIEF DESCRIPTION OF THE DRAWINGS

FIG. 1 is a block diagram of a schematic configuration of a camera module according to a first embodiment of the present invention;

FIG. 2 is a block diagram of a schematic configuration of a manufacturing apparatus of the camera module;

FIG. 3 is a flowchart of a manufacturing process of the camera module and a restoring process of captured image data;

FIG. 4 is a schematic diagram for explaining an image sensor virtually divided into a plurality of areas;

FIG. 5 is a flowchart of a manufacturing process of a camera module according to a second embodiment of the present invention and a correcting process of a captured image;

FIG. 6 is a schematic diagram for explaining a state that the entire surface of an image sensor according to the second embodiment is virtually divided into nine areas;

FIG. 7 is an enlarged diagram of an area T1;

FIG. 8 is a schematic diagram for explaining a state that the entire surface of an image sensor according to a third embodiment of the present invention is virtually divided into nine areas;

FIG. 9 is a block diagram of a schematic configuration of a camera module according to a fourth embodiment of the present invention;

FIG. 10 is a flowchart of a manufacturing process of the camera module according to the fourth embodiment and a restoring process of captured image data;

FIG. 11 is a schematic diagram for explaining aberration components in virtually divided areas of an image sensor;

FIG. 12 is an enlarged diagram of areas T1 and T5;

FIG. 13 is a flowchart of a process in which, in a sixth embodiment of the present invention, one area is selected and measured PSF data thereof is held; and

FIG. 14 depicts a schematic cross-sectional configuration of a camera module and an assembly device according to a seventh embodiment of the present invention.

### DETAILED DESCRIPTION OF THE INVENTION

Exemplary embodiments of an image recording device, a manufacturing apparatus of an image recording device, and a manufacturing method of an image recording device according to the present invention will be explained below in detail with reference to the accompanying drawings. The present invention is not limited to the following embodiments.

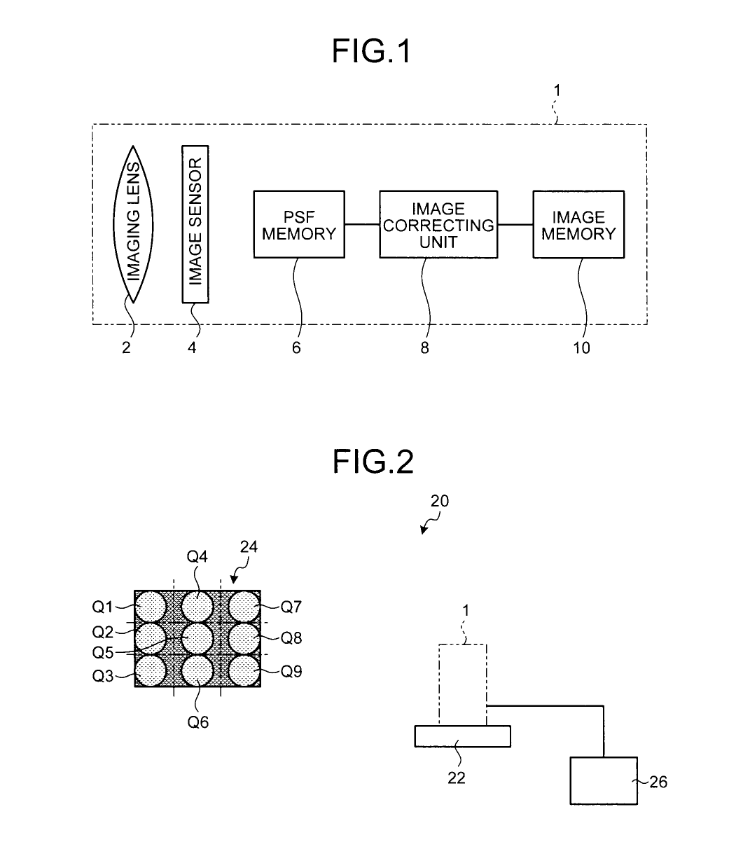

A configuration of a camera module (image recording device) 1 is explained first. FIG. 1 is a block diagram of a schematic configuration of the camera module 1 according to a first embodiment of the present invention. An imaging lens 2 takes the light from a subject. An image sensor 4 converts light from the subject to a signal charge to acquire image data. A PSF memory (memory) 6 holds PSF data for restoring the acquired image data. An image correcting unit (restoring unit) 8 performs correction such as restoration of the image data based on the PSF data. An image memory 10 records and holds the corrected image data. A process of holding the PSF data in the PSF memory 6, a correcting process of the image by the image correcting unit 8, and the like are explained later.

A configuration of a manufacturing apparatus 20 of the camera module 1 is explained next. FIG. 2 is a block diagram of a schematic configuration of the manufacturing apparatus 20 of the camera module 1. The manufacturing apparatus 20 includes a mounting portion 22, an adjustment chart 24, and a controller 26. The camera module 1 is mounted on the mounting portion 22 and positioned in the manufacturing apparatus 20. The camera module in a state with the imaging lens 2 and the image sensor 4 being assembled is mounted on the mounting portion 22. That is, in the camera module 1, an individual difference such as an assembly error occurs when the camera module 1 is mounted on the mounting portion 22 of the manufacturing apparatus 20.

The adjustment chart 24 is captured by the camera module 1 for acquiring the PSF data held in the PSF memory 6. When the camera module 1 captures the adjustment chart 24, the entire surface of the image sensor 4 is virtually divided into nine areas (areas Q1 to Q9) of 3×3 (rows by columns). The adjustment chart 24 is a point image chart including point images so that the PSF data can be acquired by captured data. A positional relation between the mounting portion 22 and the adjustment chart 24 is set to be a positional relation suitable for capturing the adjustment chart 24 by the camera module 1 mounted on the mounting portion 22.

The controller 26 controls the camera module 1 mounted on the mounting portion 22. Specifically, the controller 26 causes the camera module 1 mounted on the mounting portion 22 to capture the adjustment chart 24. That is, the controller 26 functions as a chart capturing unit to cause the camera module 1 to capture the adjustment chart.

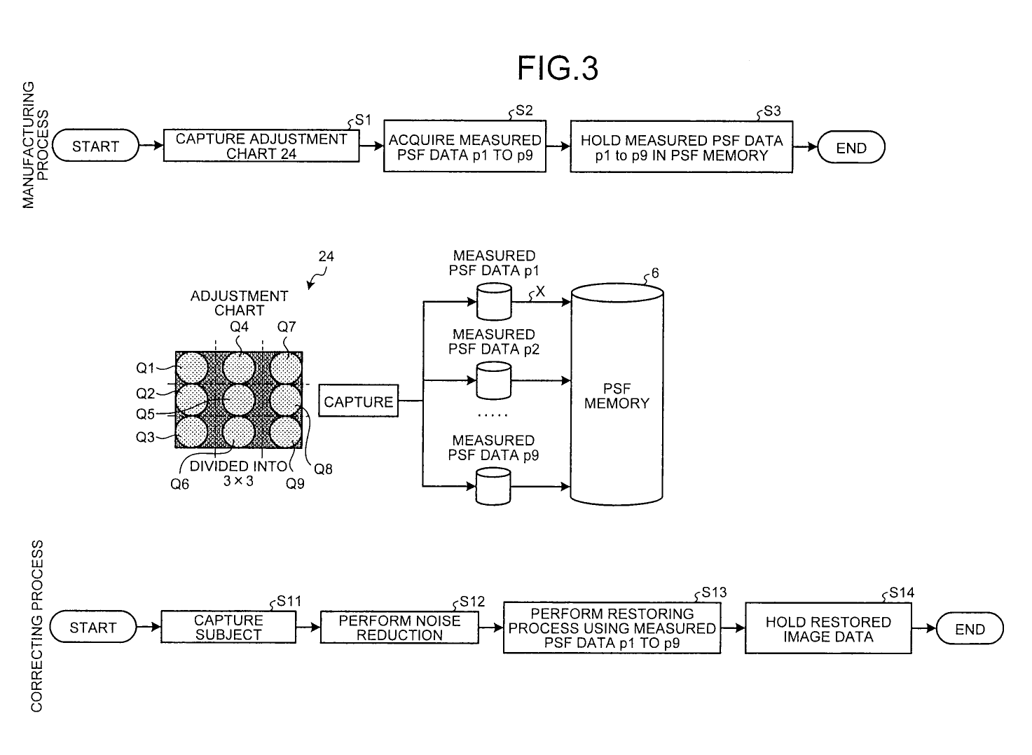

A process of holding the PSF data in the PSF memory 6 included in the camera module 1 is explained next. FIG. 3 is a flowchart of a manufacturing process of the camera module 1 and a restoring process of the captured image data. The controller 26 causes the camera module 1 mounted on the mounting portion 22 to capture the adjustment chart 24 (Step S1). Accordingly, the PSF data including a manufacturing error of the imaging lens 2 and an assembly error of the camera module 1 can be acquired for nine areas divided into a matrix of 3×3 (Step S2). The PSF data acquired by capturing the adjustment chart is referred to as measured PSF data. Nine pieces of measured PSF data p1 to p9 are held in the PSF memory 6 (Step S3, part indicated by an arrow X). Accordingly, as far as the PSF memory 6 is accessed, the measured PSF data p1 to p9 can be read and used at all times. Because the adjustment chart is captured by the camera module 1 already assembled, that is, the camera module 1 in which an individual difference has been generated, to acquire the measured PSF data p1 to p9, the measurement data p1 to p9 reflect the individual difference of the camera module 1.

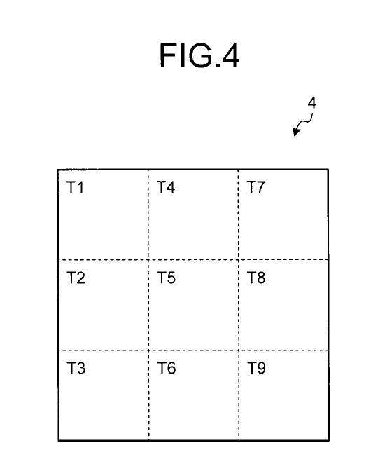

A process of correcting the image data captured by the camera module 1 is explained next. The camera module 1 first captures a subject (Step S11). Accordingly, a raw image can be acquired as image data of the subject. The image correcting unit 8 performs noise reduction with respect to the raw image (Step S12). The image correcting unit 8 then performs a restoring process using the measured PSF data p1 to p9 with respect to the raw image (Step S13). FIG. 4 is a schematic diagram for explaining the image sensor 4 virtually divided into a plurality of areas. The image sensor 4 is virtually divided into nine areas (T1 to T9). The image correcting unit 8 performs the restoring process of the image data by using the measured PSF data p1 to p9 corresponding to respective areas T1 to T9 with respect to the raw image acquired from the respective areas T1 to T9. For example, the image correcting unit 8 performs the restoring process by using the measured PSF data p1 with respect to the raw image acquired from the area T1. The restored image data is held in the image memory (Step S14).

A restoration effect depends on an image restoration algorithm, and for example, an image restoration method by the Richardson-Lucy method can be used. Accordingly, an image close to an actual image with less optical strain or blur can be acquired. Even if there is a manufacturing error of the imaging lens 2, an image close to an actual image can be acquired by the restoring process explained in the first embodiment, thereby enabling to suppress the manufacturing accuracy required for the imaging lens 2 and reduce the manufacturing cost. Further, even if there is an assembly error in the camera module 1, the assembly accuracy required for the camera module 1 can be relaxed and the manufacturing cost can be reduced, because an image close to the actual image can be acquired by the restoring process.

The adjustment chart 24 is a point image chart including point images; however, it is not limited thereto, and the adjustment chart 24 can be a chart in which the captured data in the respective areas Q1 to Q9 can be used as the PSF data or a chart in which the pieces of captured data are images having a strong correlation with the PSF data.

The adjustment chart 24 is divided into nine areas of 3×3; however, it can be divided into M×N areas of M rows by N columns, where M and N are integers. As M×N becomes larger, the accuracy of the restoring process can be improved.

The dividing direction is not limited to a matrix shape and it can be a curvilinear coordinate, for example. The number of divisions does not depend on the dividing direction, and can be arbitrary two points. The PSF data is not limited to image data. For example, a PSF image table can be held in a separate ROM, and the PSF memory 6 can hold difference data with respect to the PSF image data and a ratio coefficient. When the difference data and the ratio coefficient have a small capacity as compared with the image data, the capacity of the PSF memory 6 included in the camera module 1 can be made small.

The PSF data can be held in an external memory instead of the PSF memory 6 in the camera module 1. An algorithm different from that of the Richardson-Lucy method can be used as the algorithm of image restoration.

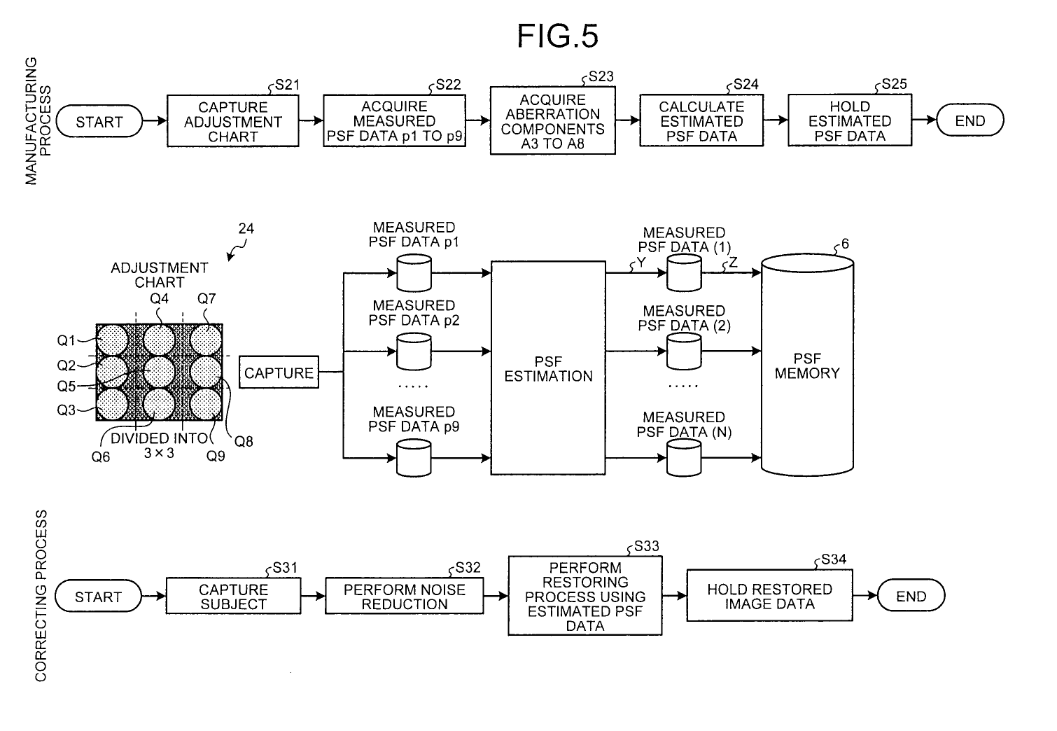

A second embodiment of the present invention is explained with reference to FIGS. 5 to 7. Constituent elements identical to those in the first embodiment are denoted by like reference numerals and redundant explanations thereof will be omitted. The camera module 1 and the manufacturing apparatus 20 thereof according to the second embodiment are the same as those explained in the first embodiment and shown in FIGS. 1 and 2.

In the second embodiment, the controller 26 estimates more pieces of PSF data based on the measured PSF data p1 to p9 acquired from the adjustment chart 24. The controller 26 functions as an estimating unit that estimates the PSF data.

FIG. 5 is a flowchart of a manufacturing process of the camera module 1 and a correcting process of the captured image. The controller 26 first causes the camera module 1 to capture the adjustment chart 24 (Step S21) to acquire the PSF data p1 to p9 corresponding to nine areas similarly to the first embodiment (Step S22). The controller 26 estimates the PSF data for each area when the entire surface of the image sensor 4 is divided into 6561 areas of 81×81 by using the PSF data p1 to p9, to acquire estimated PSF data. Specifically, the controller 26 estimates the estimated PSF data by acquiring a magnitude of a basic aberration amount such as spherical aberrations, coma aberrations, and astigmatism, which are third-order aberrations, and a magnitude of an out-of-focus amount, from the measured PSF data p1 to p9.

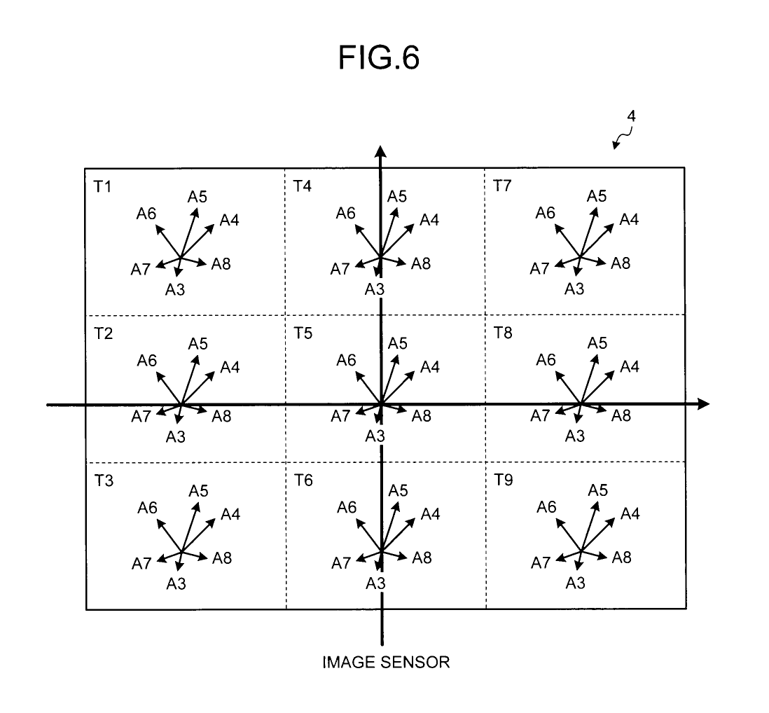

FIG. 6 is a schematic diagram for explaining a state that the entire surface of the image sensor 4 is virtually divided into nine areas. Because the spherical aberrations, coma-aberrations, and astigmatism have directionality, these elements are considered as independent components. As shown in FIG. 6, when it is assumed that respective aberration components are A3 to A8, aberration components A3 to A8 can be acquired for each of the areas T1 to T9 (Step S23). The controller 26 performs a polynomial approximation by using a least square method with respect to the entire surface of the image sensor 4 based on the aberration components A3 to A8 for each of the areas T1 to T9. The controller 26 calculates a PSF for each area divided into a matrix of 81×81, that is, 6561 area as the estimated PSF data by using an approximating polynomial (Step S24, part indicated by an arrow Y). The calculated estimated PSF data is held in the PSF memory 6 (Step S25, part indicated by an arrow Z). The controller 26 functions as an input unit that inputs the estimated PSF data to the PSF memory 6 to be held therein.

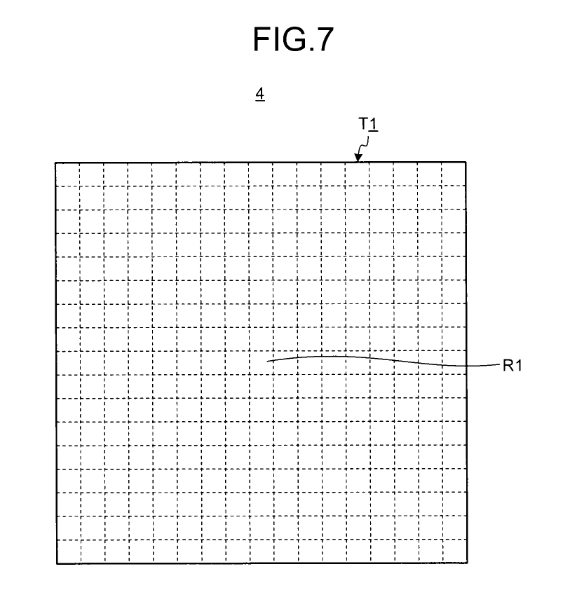

FIG. 7 is an enlarged diagram of the area T1. When the entire surface of the image sensor 4 is divided into 6561 areas, the area T1 is divided into a matrix of 17×17. Among these areas, the measured PSF data p1 directly acquired by capturing the adjustment chart indicates the PSF corresponding to an area (representative area) R1. In the second embodiment, the controller 26 estimates the PSF in an area other than area S1 by using the aberration components to acquire the estimated PSF data.

The restoring process of the captured image is performed by using the 6561 PSF data (measured PSF data and estimated PSF data) held in the PSF memory 6 with respect to the raw image having subjected to noise reduction similarly to the first embodiment (Steps S31 to S34).

Generally, even in the same area T1, the PSF is different for each area. In the first embodiment, the measured PSF data p1 is adopted as the PSF data representing the area T1, and the measured PSF data p1 is applied to the entire area T1 to restore the image data. On the other hand, in the second embodiment, the controller 26 further subdivides the area T1, and estimates the PSF data for each subdivided area to acquire the estimated PSF data. Because the restoring process is performed by using the estimated PSF data, a more accurate restoring process can be realized.

In the second embodiment, the controller 26 separate from the camera module 1 has a function as an estimating unit that estimates the estimated PSF data, however, the estimating unit can be provided in the camera module 1.

The adjustment chart 24 is divided into nine areas of 3×3; however, it can be divided into M×N areas of M rows by N columns (M and N are integers). As M×N becomes larger, the accuracy of the restoring process can be improved.

Further, the dividing direction is not limited to a matrix shape, and can be a curvilinear coordinate, for example. The number of divisions does not depend on the dividing direction, and can be arbitrary two points. The PSF data is not limited to image data. For example, a PSF image table can be held in a separate ROM, and the PSF memory 6 can hold difference data with respect to the PSF image data and a ratio coefficient. When the difference data and the ratio coefficient have a small capacity as compared with the image data, the capacity of the PSF memory 6 included in the camera module 1 can be made small.

An estimation approximation method of the PSF data is not limited to the least square method, and other methods can be used. The PSF data can be held not in the PSF memory but in an external memory. An algorithm different from that of the Richardson-Lucy method can be used as the algorithm of image restoration. The controller 26 can calculate the aberration components in advance, and not the PSF data but the aberration components can be held in the PSF memory.

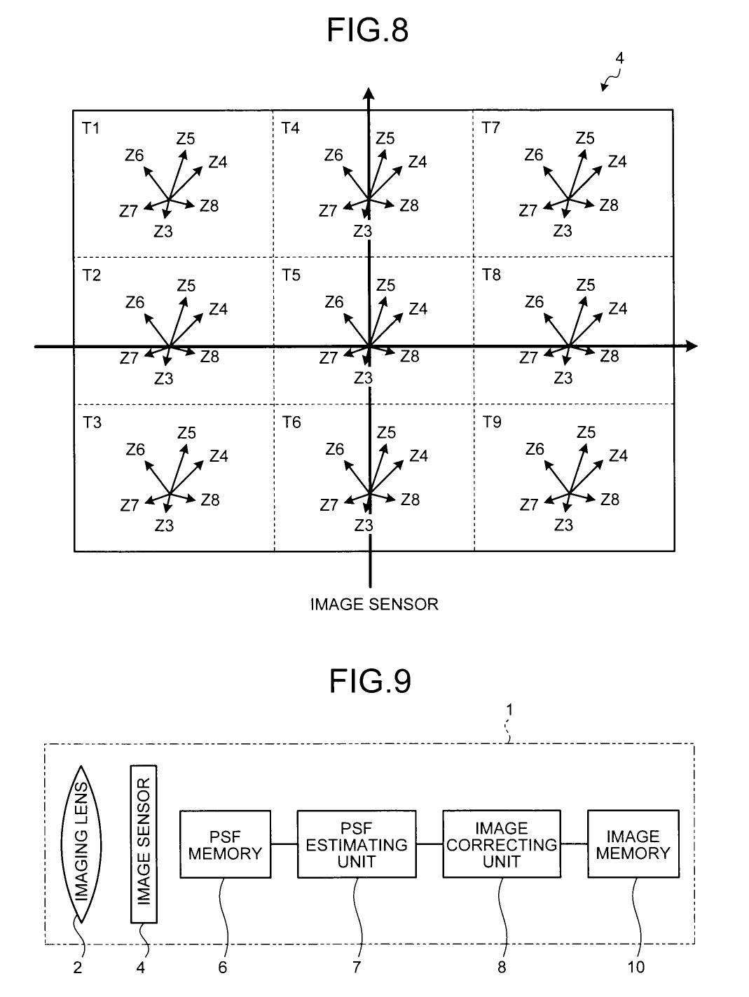

A third embodiment of the present invention is explained with reference to FIG. 8. Constituent elements identical to those in the above embodiments are denoted by like reference numerals and redundant explanations thereof will be omitted. In the third embodiment, the entire surface of the image sensor 4 is virtually divided into 6561 areas of 81×81 and the PSF data for each area is estimated similarly to the second embodiment. The controller 26 also functions as an estimating unit.

In the third embodiment, the controller 26 acquires the basic aberration amount such as spherical aberrations, coma-aberrations, and astigmatism, which are third-order aberrations, and a wavefront aberration amount such as an out-of-focus amount by performing Fourier transform for nine pieces of PSF data acquired by the same process as in the second embodiment.

FIG. 8 is a schematic diagram for explaining a state that the entire surface of the image sensor 4 is virtually divided into nine areas. Because spherical aberrations, coma-aberrations, and astigmatism have directionality, these elements are considered as independent components. Like in the second embodiment, when it is assumed that respective aberration components are Z3 to Z8, aberration components Z3 to Z8 can be acquired for each of the areas T1 to T9. The controller 26 performs a polynomial approximation by using the least square method with respect to the entire surface of the image sensor 4 based on the aberration components Z3 to Z8 for each of the areas T1 to T9. The controller 26 calculates a wavefront aberration amount for each of the areas divided into 6561 areas by using the approximating polynomial. The controller 26 calculates the estimated PSF data by performing inverse Fourier transform with respect to the calculated wavefront aberration amount. The estimated PSF data for each of the areas divided into 6561 areas is held in the PSF memory 6. The flow of calculating the estimated PSF data is substantially identical to that of the second embodiment, and thus explanations thereof will be omitted. The restoring process of the image using the PSF data held in the PSF memory 6 is substantially identical to that of the second embodiment, and thus detailed explanations thereof will be omitted.

Generally, even in the same area T1, the PSF is different for each area. In the first embodiment, the measured PSF data p1 is adopted as the PSF data representing the area T1, and the measured PSF data p1 is applied to the entire area T1 to restore the image data. On the other hand, in the third embodiment, the controller 26 further subdivides the area T1, and estimates the PSF data for each subdivided area to acquire the estimated PSF data. Because the restoring process is performed by using the estimated PSF data, a more accurate restoring process can be realized.

Furthermore, in the third embodiment, because the measured PSF data p1 to p9 are Fourier-transformed to acquire the aberration components, respective aberration components Z3 to Z8 can be handled as complete independent components, and the PSF data can be estimated more accurately. Accordingly, a more accurate restoring process can be realized.

In the third embodiment, the controller 26 separate from the camera module 1 has a function as an estimating unit that estimates the PSF data; however, the estimating unit can be separately provided in the camera module 1.

The adjustment chart 24 is divided into nine areas of 3×3; however, it can be divided into M×N areas of M rows by N columns (M and N are integers). As M×N becomes larger, the accuracy of the restoring process can be improved.

The dividing direction is not limited to a matrix shape, and can be a curvilinear coordinate, for example. The number of divisions does not depend on the dividing direction, and can be arbitrary two points. The PSF data is not limited to image data. For example, a PSF image table can be held in a separate ROM, and the PSF memory 6 can hold difference data with respect to the PSF image data and a ratio coefficient. When the difference data and the ratio coefficient have a small capacity as compared with the image data, the capacity of the PSF memory 6 included in the camera module 1 can be made small.

The estimation approximation method of the PSF data is not limited to the least square method, and other methods can be used. The PSF data can be held not in the PSF memory but in an external memory. An algorithm different from that of the Richardson-Lucy method can be used as the algorithm of image restoration. The controller 26 can calculate the aberration components in advance, and not the PSF data but the aberration components can be held in the PSF memory.

A fourth embodiment of the present invention is explained with reference to FIGS. 9 to 12. FIG. 9 is a block diagram of a schematic configuration of the camera module 1 according to the fourth embodiment. Constituent elements identical to those in the above embodiments are denoted by like reference numerals and redundant explanations thereof will be omitted. The configuration of the manufacturing apparatus 20 according to the fourth embodiment is the same as that of the manufacturing apparatus explained in the first embodiment and shown in FIG. 2.

The PSF data held in the PSF memory 6 includes the measured PSF data and design PSF data. The design PSF data is PSF data indicating a PSF acquired from a design value of the imaging lens 2. The measured PSF data is PSF data indicating a PSF acquired from captured data acquired by capturing the adjustment chart by the camera module 1.

A PSF estimating unit (estimating unit) 7 estimates other pieces of PSF data (PSF data of other areas) based on the measured PSF data and the design PSF data held in the PSF memory 6. The image correcting unit (restoration unit) 8 performs correction such as a restoring process of image data using the PSF data. The image memory 10 stores therein and holds the corrected image data. A process of storing the PSF data in the PSF memory 6, a process of correcting images by the image correcting unit 8, and a process of estimating the PSF data of other areas by the PSF estimating unit 7 are explained later.

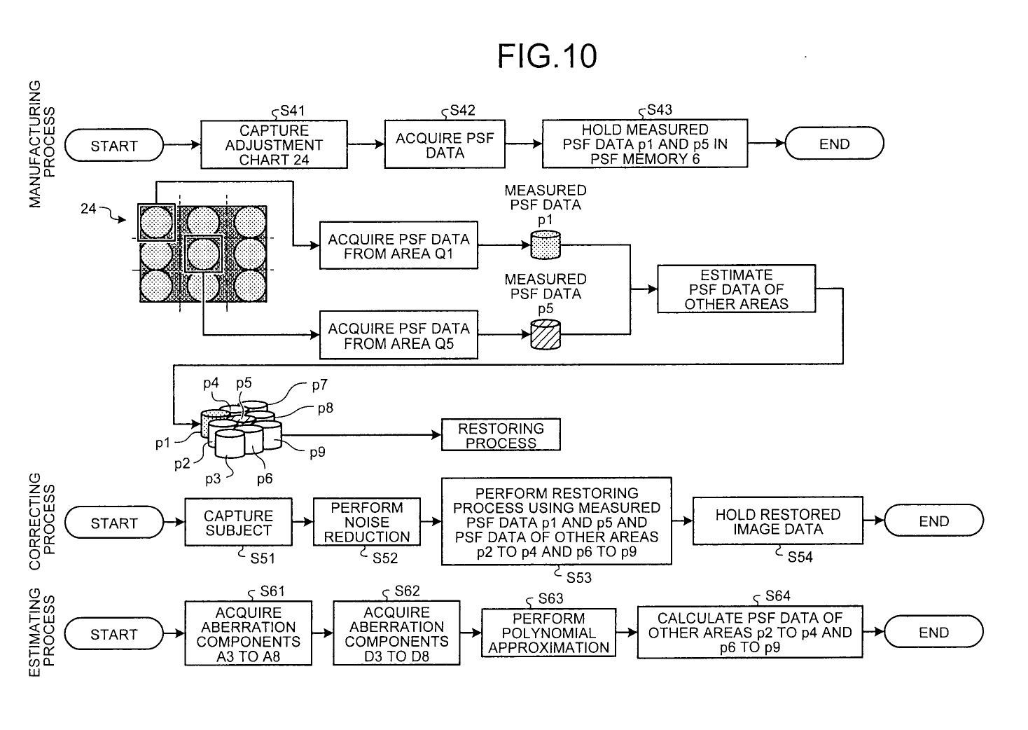

The process of storing the PSF data in the PSF memory 6 included in the camera module 1 is explained. FIG. 10 is a flowchart of a manufacturing process of the camera module 1, a correcting process of the captured image data, and an estimating process of the PSF data of other areas. The controller 26 causes the camera module 1 mounted on the mounting portion 22 to capture the adjustment chart 24 (Step S41). Accordingly, the PSF data including a manufacturing error of the imaging lens 2 and an assembly error of the camera module 1 can be acquired for nine areas divided into 3×3 (Step S42). The controller 26 inputs the PSF data acquired from area Q1 and the PSF data acquired from area Q5 of the acquired PSF data to the PSF memory 6 as the measured PSF data to be held therein (Step S43).

That is, the PSF memory 6 holds the PSF data of two areas of a central part and a peripheral part of the image sensor 4 as the measured PSF data. The PSF data acquired from area Q1 is designated as the measured PSF data p1 and the PSF data acquired from area Q5 is designated as measured PSF data p5. Accordingly, the measured PSF data p1 and p5 can be read and used any time as far as the PSF memory 6 is accessed. The pieces of the measured PSF data p1 and p5 are acquired by capturing the adjustment chart by the camera module 1 already assembled, that is, the camera module 1 having an individual difference. Accordingly, the measurement data p1 and p5 reflect the individual difference of the camera module 1.

The correcting process of the image data captured by the camera module 1 is explained next. The camera module 1 first captures a subject (Step S51). Accordingly, a raw image can be acquired as the image data of the subject. The image correcting unit 8 performs noise reduction with respect to the raw image (Step S52). The image correcting unit 8 performs the restoring process with respect to the raw image. As shown in FIG. 4, the image sensor 4 is virtually divided into nine areas (T1 to T9). The image correcting unit 8 performs the restoring process with respect to the raw image acquired from the area T1 by using the measured PSF data p1. The restoring process is performed with respect to the raw image acquired from the area T5 by using measured PSF data p5. The restoring process is performed to other areas different from the areas T1 and T5 by using the PSF data p2 to p4 and p6 to p9 of other areas estimated by the PSF estimating unit 7 (Step S53). The PSF data p2 to p4 and p6 to p9 of other areas are PSF data in the areas T2 to T4 and T6 to T9, and are estimated by the PS estimating unit 7. Estimation of the PSF data p2 to p4 and p6 to p9 of other areas is described later in detail. The corrected image data is held in the image memory 10 (Step S54).

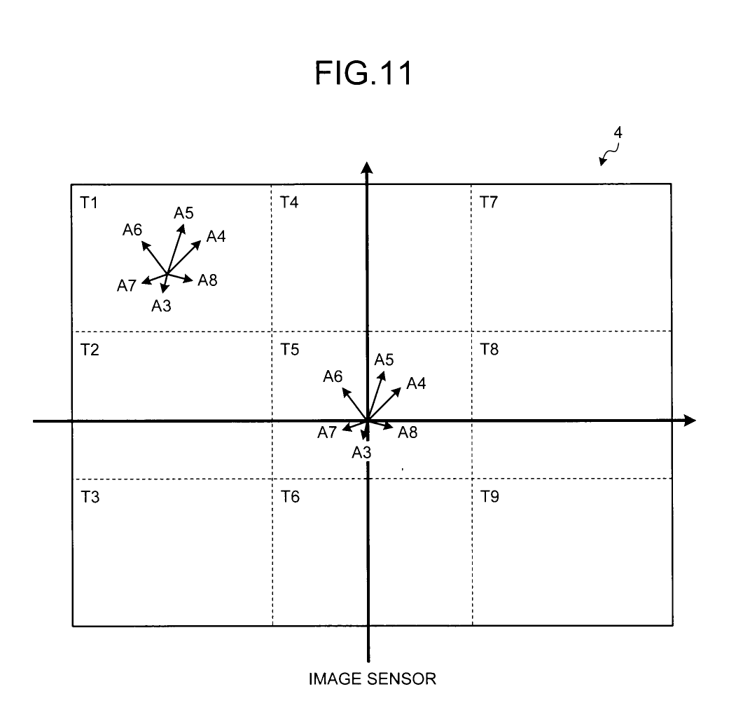

The estimating process of the PSF data p2 to p4 and p6 to p9 of other areas performed by the PSF estimating unit 7 is explained next. The PSF estimating unit 7 estimates the PSF data p2 to p4 and p6 to p9 of other areas based on the estimated PSF data p1 and p5 and the design PSF data. The PSF estimating unit 7 acquires a magnitude of the basic aberration amount such as spherical aberrations, coma-aberrations, and astigmatism, which are the third-order aberrations, and a magnitude of the out-of-focus amount from the measured PSF data p1 and p5. Because spherical aberrations, coma-aberrations, and astigmatism have directionality, these elements are considered as independent components. As shown in FIG. 11, respective aberration components A3 to A8 can be acquired (Step S61).

The PSF correcting unit 7 also acquires the magnitude of the basic aberration amount such as spherical aberrations, coma-aberrations, and astigmatism, which are the third-order aberrations, and the magnitude of the out-of-focus amount in the same manner from the design PSF data. These independent components are designated as aberration components D3 to D8 (Step S62). When there is no manufacturing error of the imaging lens 2 or no assembly error of the camera module 1, A(i) and D(i) match each other. However, because it is generally difficult to eliminate the manufacturing error and the assembly error, A(i) and D(i) are different in the camera module 1.

Therefore, the PSF estimating unit 7 performs a polynomial approximation by using the least square method with respect to aberration components A3 to A8 and D3 to D8 (Step S63). The PSF estimating unit 7 calculates the PSF data in the areas T2 to T4 and T6 to T9, that is, the PSF data p2 to p4 and p6 to p9 of other areas by using the approximating polynomial (Step S64). The PSF estimating unit 7 obtains a change rate of the aberration components from the measurement value and the design value, and estimates the PSF data in the entire surface of the image sensor 4 based on the change rate. The image restoring process at Step S53 is performed by using the PSF data p2 to p4 and p6 to p9 of other areas.

An effect of restoration depends on the image restoration algorithm; however, for example, an image restoration method according to the Richardson-Lucy method can be used. Accordingly, an image close to an actual image having less optical strain or blur can be acquired. Even if there is a manufacturing error of the imaging lens 2, because an image close to the actual image can be acquired by the restoring process explained in the first embodiment, the manufacturing accuracy required for the imaging lens 2 can be suppressed to reduce the manufacturing cost.

The measurement data p1 and p5 and the design PSF data need only to be held in the PSF memory 6, the capacity of the PSF memory 6 can be made small as compared with a case that all pieces of the PSF data in the entire surface of the image sensor 4 are held, and the parts cost can be suppressed.

The adjustment chart 24 is a point image chart including point images; however, it is not limited thereto, and the adjustment chart 24 can be a chart in which the captured data in the respective areas Q1 to Q9 can be used as the PSF data or a chart in which the pieces of captured data are images having a strong correlation with the PSF data.

The PSF data acquired from area Q5 which is the central part of the adjustment chart 24 and the PSF data acquired from area Q1 which is the peripheral part thereof are designated as the measured PSF data; however, it is not limited thereto, and arbitrary two points can be selected.

The adjustment chart 24 is divided into nine areas of 3×3; however, it can be divided into M×N areas of M rows by N columns (M and N are integers). As M×N becomes larger, the accuracy of the restoring process can be improved.

The dividing direction is not limited to a matrix shape, and can be a curvilinear coordinate, for example. The number of divisions does not depend on the dividing direction, and can be arbitrary two points. The PSF data is not limited to image data. For example, a PSF image table can be held in a separate ROM, and the PSF memory 6 can hold difference data with respect to the PSF image data and a ratio coefficient. When the difference data and the ratio coefficient have a small capacity as compared with the image data, the capacity of the PSF memory 6 included in the camera module 1 can be made small. The PSF memory 6 can hold aberration components calculated in advance as the PSF data.

The PSF data can be held not in the PSF memory 6 in the camera module 1 but in an external memory. An algorithm different from the Richardson-Lucy method can be used as the algorithm of image restoration. The estimation method of the PSF data is not necessarily limited to the least square method.

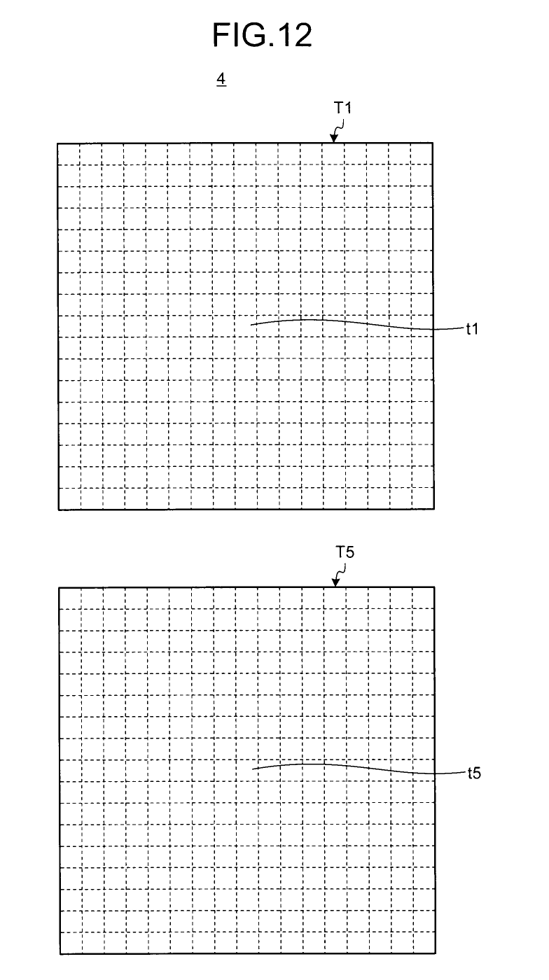

A modification of the fourth embodiment is explained next. In this modification, when estimating the PSF data of other areas, the PSF estimating unit 7 subdivides the areas T1 to T9 of the image sensor 4, to divide the entire surface of the image sensor 4 into 6561 areas of 81×81. FIG. 12 is an enlarged diagram of the areas T1 and T5. The PSF estimating unit 7 divides the areas T1 to T9 into 289 areas of 17×17. In this case, the estimated PSF data p1 becomes the PSF data in an area t1, and measured PSF data p5 becomes the PSF data in an area t5.

That is, the PSF estimating unit 7 estimates the PSF data in each area other than the area t1 in the area T1 and in each area other than the area t5 in the area T5 as the PSF data of other areas. The PSF estimating unit 7 also estimates the PSF data in the subdivided respective areas of the areas T2 to T4 and T6 to T9 as the PSF data of other areas. The estimation method of the PSF data of other areas is identical to that of the fourth embodiment, and thus detailed explanations thereof will be omitted.

Generally, even in the same area T1, the PSF is different for each area. In the fourth embodiment, the measured PSF data p1 is adopted as the PSF data representing the area T1, and the measured PSF data p1 is applied to the entire area T1 to restore the image data. On the other hand, in this modification, the controller 26 further subdivides the area T1, and estimates the PSF data for each subdivided area to acquire the estimated PSF data of other areas. Because the restoring process is performed by using the PSF data of other areas, the restoring process can be performed by using the PSF data corresponding to the area, and more accurate restoring process can be realized. In this modification, the PSF estimating unit 7 divides the entire area into 6561 areas of 81×81; however, the entire area can be divided into I×J areas of I rows by J columns (I and J are integers). As I×J becomes larger, the accuracy of the restoring process can be improved.

A fifth embodiment of the present invention is explained with reference to the drawings. Constituent elements identical to those in the above embodiments are denoted by like reference numerals and redundant explanations thereof will be omitted. In the fifth embodiment, the PSF estimating unit 7 acquires the basic aberration amount such as spherical aberrations, coma aberrations, and astigmatism, which are third-order aberrations, and the out-of-focus amount by performing the Fourier transform with respect to the measured PSF data p1 and p5 and the design PSF data.

Because spherical aberrations, coma-aberrations, and astigmatism have directionality, these elements are considered as independent components. Like in the fourth embodiment, respective aberration components are designated as A3 to A8 and D3 to D8. The PSF estimating unit 7 performs a polynomial approximation by using the least square method with respect to aberration components A3 to A8 and D3 to D8. The PSF estimating unit 7 calculates a wavefront aberration amount by using the approximating polynomial based on the corrected coefficient. The PSF estimating unit 7 calculates the PSF data of other areas by performing inverse Fourier transform with respect to the calculated wavefront aberration amount. The PSF estimating unit 7 can calculate the PSF data in the areas T2 to T4 and T6 to T9 of the areas obtained by dividing the image sensor 4 into nine areas, or can further subdivide the areas T1 to T9 to calculate the PSF data in each subdivided area similarly to the modification of the fourth embodiment as the PSF data of other areas. The restoring process of the image data can be performed by using the measured PSF data and the PSF data of other areas similarly to the fourth embodiment.

In the fifth embodiment, because the measured PSF data and the design PSF data are Fourier-transformed for obtaining the aberration components, respective aberration components A3 to A8 and D3 to D8 can be handled as the complete independent components, and the estimation accuracy of the PSF data of other areas can be improved. Accordingly, more accurate restoring process can be realized.

A modification of the fifth embodiment is explained next. In this modification, measured PSF data p5 and design PSF data in the area T5, which is the central part of the image sensor 4, are held in the PSF memory 6, and the PSF data in the area T1, which is the peripheral part of the image sensor 4, is not held.

The PSF estimating unit 7 acquires the wavefront aberration amounts such as a basic aberration amount such as spherical aberrations, coma aberrations, and astigmatism, which are third-order aberrations, and the out-of-focus amount by performing the Fourier transform with respect to measured PSF data p5 and the design PSF data. Because spherical aberrations, coma-aberrations, and astigmatism have directionality, these elements are considered as independent components. Like in the fourth embodiment, respective aberration components are designated as A3 to A8 and D3 to D8. The PSF estimating unit 7 performs a polynomial approximation by using the least square method with respect to aberration components A3 to A8 and D3 to D8. The PSF estimating unit 7 calculates the wavefront aberration amount by using the approximating polynomial based on the corrected coefficient. The PSF estimating unit 7 calculates the PSF data of other areas by performing inverse Fourier transform with respect to the calculated wavefront aberration amount. The PSF estimating unit 7 can calculate the PSF data in the areas T2 to T4 and T6 to T9 of the areas obtained by dividing the image sensor 4 into nine areas, or can further subdivide the areas T1 to T9 to calculate the PSF data in each subdivided area as the PSF data of other areas, similarly to the modification of the fourth embodiment. The restoring process of the image data can be performed by using the measured PSF data and the PSF data of other areas similarly to the fourth embodiment.

In the modification of the fifth embodiment, because the measured PSF data and the design PSF data are Fourier-transformed for obtaining the aberration components, respective aberration components A3 to A8 and D3 to D8 can be handled as the complete independent components, and the estimation accuracy of the PSF data of other areas can be improved. Accordingly, more accurate restoring process can be realized. The PSF data of other areas can be estimated without performing the Fourier transform.

Further, the pieces of data stored in the PSF memory 6 are one piece of measured PSF data p5 and the design PSF data. Therefore, the capacity of the PSF memory 6 can be made small as compared with a case that two pieces of the PSF data p1 and p5 are held, and the parts cost can be further suppressed.

The data held in the PSF memory is not limited to measured PSF data p5 in the area T5, which is the central part of the image sensor 4, and can be PSF data in one area selected from the peripheral the areas T1 to T4 and T6 to T9.

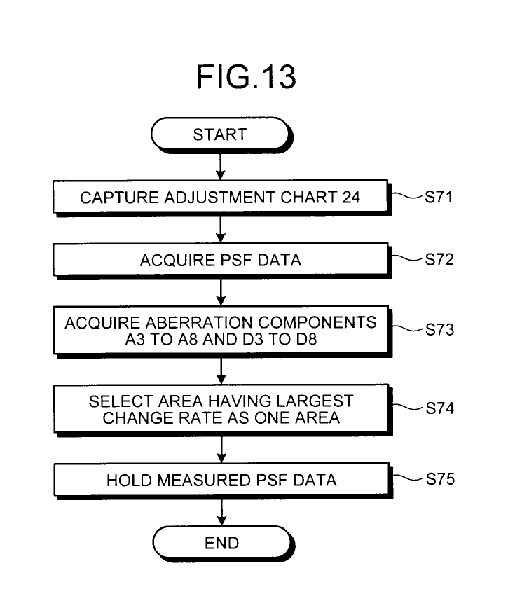

A sixth embodiment of the present invention is explained with reference to FIG. 13. Constituent elements identical to those in the above embodiments are denoted by like reference numerals and redundant explanations thereof will be omitted. In the sixth embodiment, the controller 26 in the manufacturing apparatus 20 functions as a selecting unit that selects one area from a plurality of virtually divided areas of the image sensor 4 based on the captured data of the adjustment chart 24 captured by the camera module 1 and the design value of the imaging lens 2. The controller 26 further functions as an input unit that inputs PSF data in the selected area to the PSF memory 6 as the measured PSF data to be held therein.

FIG. 13 is a flowchart of a process in which one area is selected and the measured PSF data thereof is held. The controller 26 first causes the camera module 1 mounted on the mounting portion 22 to capture the adjustment chart 24 (Step S71). Accordingly, PSF data including a manufacturing error of the imaging lens 2 and an assembly error of the camera module 1 can be acquired for nine areas divided into 3×3 (Step S72). The controller 26 performs Fourier transform with respect to the acquired PSF data and design PSF data to acquire aberration components A3 to A8 and D3 to D8 for each of the areas T1 to T9 of the image sensor 4 (Step S73). The controller 26 then calculates a change rate of aberration components A3 to A8 and D3 to D8 for each of the areas T1 to T9 of the image sensor 4, to select an area having the largest change rate as the one area (Step S74). The controller 26 inputs the PSF data in the area selected as the one area to the PSF memory 6 as the measured PSF data to be held therein (step S75).

The estimating process of PSF data of other areas and the restoring process of the image data using the measured PSF data and the design PSF data held in the PSF memory are the same as those in the above embodiments, and thus detailed explanations thereof will be omitted.

As described above, the accuracy of the PSF data of other areas estimated by the PSF estimating unit 7 can be improved by selecting the area having the largest change rate of the design value and the measured value as the one area. Further, because the change rate is calculated for each camera module 1 to select the one area, an area suitable for estimating the PSF data of other areas of the camera module 1 can be set as the one area. Accordingly, a difference in accuracy of the restoring process of image data by the camera module 1 can be suppressed, thereby enabling to provide the camera module 1 with less difference in quality. Further, because a difference in quality decreases, the yield can be improved further. In the sixth embodiment, one area is selected. However, two or more areas can be selected and PSF data of these areas can be held as the measured PSF data.

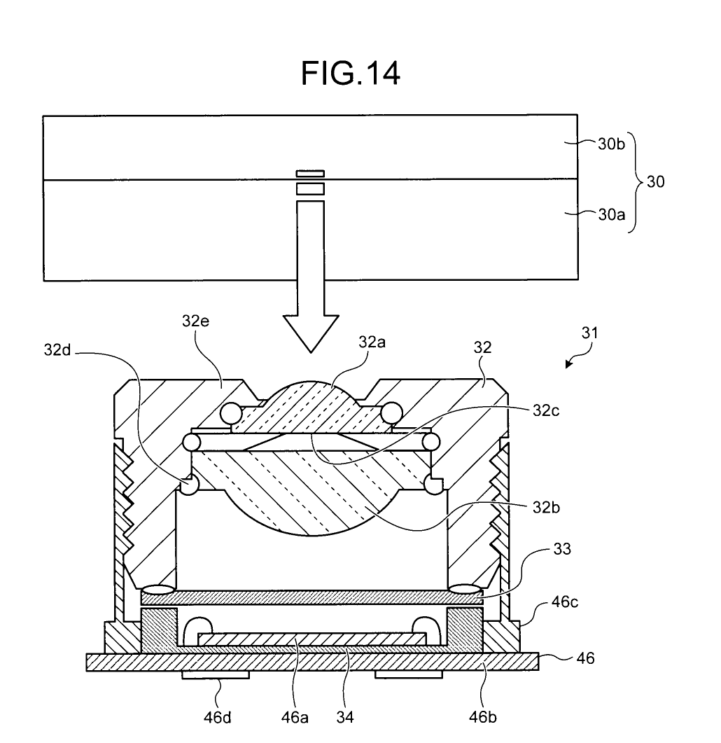

A seventh embodiment of the present invention is explained with reference to FIG. 14. In the seventh embodiment, the configurations of the imaging lens and the image sensor of the camera module shown in FIGS. 1 and 9 are explained in more detail.

FIG. 14 is a sectional view of imaging lenses 32a and 32b and an image sensor 34 of a camera module 31 according to the seventh embodiment. In FIG. 14, a schematic configuration of an assembly device to be used at the time of assembling the camera module 31 is also shown. The camera module 31 includes a lens barrel 32 and a circuit board 46 with a barrel holder 46c.

The lens barrel 32 includes the imaging lenses 32a and 32b, an aperture 32c, a lens holder 32e, and an infrared filter 33. The imaging lenses 32a and 32b have a function of imaging an image of a subject reasonably with respect to the image sensor 34 arranged at a predetermined position. In the seventh embodiment, the imaging lens includes two lenses. The number of lenses constituting the imaging lens is not limited to two, and one lens or three or more lenses can constitute the imaging lens. The aperture 32c has a function of controlling an amount of light entering the image sensor 34 to an appropriate amount. The infrared filter 33 has a function of not transmitting unnecessary long wavelengths other than a visible range. The imaging lenses 32a and 32b and the aperture 32c are fixed to the lens holder 32e by an adhesive 32d. That is, the lens holder 32e functions as a holding unit that holds the imaging lenses 32a and 32b and the aperture 32c. A screw thread is formed on an outer circumference of the lens holder 32e.

The circuit board 46 with the barrel holder 46c includes an image sensor 46a, a circuit board 46b electrically connected via, for example, wire bonding, the barrel holder 46c that shields unnecessary light from outside and fixes the lens barrel 32, and a circuit pad 46d to be used for connection with an external circuit. A screw thread is formed on an inner circumference of the barrel holder 46c. Although not shown, a memory that holds the measured PSF data and the like can be arranged on the circuit board 46b, or can be provided outside of the circuit board 46b and connected with the image sensor via the circuit pad 46d.

The lens holder 32e has such a configuration that the lens holder 32e is screwed into the inside of the barrel holder 46c and fixed. That is, the camera module 31 can adjust a distance between the lens holder 32e and the barrel holder 46c by adjusting a screw-in depth of the lens holder 32e with respect to the barrel holder 46c. Accordingly, an optical distance, that is, a distance between the imaging lenses 32a and 32b and the image sensor 46a can be adjusted so that the image of the subject is imaged (focused) reasonably with respect to the image sensor 46a by the imaging lenses 32a and 32b.

An assembly device 30 assembles the camera module 31 having the circuit board 46 with the barrel holder 46c in which the lens barrel 32 and the image sensor 46a are provided. The assembly device 30 includes a light irradiating unit 30b that irradiates light to the camera module 31, and an optical chart 30a that confirms whether reasonable imaging has been performed at the time of screwing the lens holder 32e in the barrel holder 46c.

The optical chart 30a includes a black and white periodic pattern, for example, provided by the ISO. Light irradiated from the light irradiating unit 30b is transmitted through the optical chart 30a and imaged on the image sensor 46a. At this time, by adjusting the screw-in depth of the lens holder 32e with respect to the barrel holder 46c so that the black and white periodic pattern is imaged (focused) reasonably with respect to the image sensor 46a by the imaging lenses 32a and 32b, the camera module 31 can be assembled so that a reasonable imaging state can be achieved.

The camera module 31 is not limited to one having the configuration explained in the seventh embodiment. For example, the aperture may not be provided or a shutter may be provided, or vise versa. Methods other than a screwing method of the lens barrel can be used as a method of fixing the member, and for example, an adhesive can be used for the fixing. Further, a connection method with an external circuit is not limited to the method explained in the seventh embodiment. While the configuration of the camera module has been explained in the seventh embodiment, the seventh embodiment can be applied to any module in which an image is formed on an image sensor.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image recording device that records captured image data, the image recording device comprising:
an image sensor that converts light from a subject to a signal charge to acquire the image data;
a memory that holds measured PSF data indicating a PSF of at least one area of the image sensor virtually divided into a plurality of areas; and
a restoring unit that restores the image data by using the measured PSF data, wherein
the measured PSF data is acquired from captured data acquired by capturing an adjustment chart for virtually dividing the image sensor into a plurality of areas by the image recording device.

2. The image recording device according to claim 1, wherein the memory holds measured PSF data for each of the areas.

3. The image recording device according to claim 1, wherein
the memory holds measured PSF data indicating a PSF of one or two or more areas, which are a part of the areas, and
the image recording device further comprises:
an imaging lens that takes light from a subject; and
an estimating unit that estimates PSF data of other areas indicating a PSF of other areas, which are different from the one or two or more areas of the plurality of areas, based on design PSF data indicating a PSF acquired from a design value of the imaging lens and the measured PSF data held in the memory, and wherein
the restoring unit restores the image data by using the measured PSF data and PSF data of the other areas.

4. The image recording device according to claim 1, wherein the measured PSF data held in the memory includes at least one of difference data between the adjustment chart and the captured data, and a ratio coefficient.

5. The image recording device according to claim 1, wherein
the measured PSF data indicates a PSF of a representative area of the areas,
the memory holds estimated PSF data indicating a PSF of areas other than the representative area,
the restoring unit restores the image data by using the measured PSF data and the estimated PSF data, and
the estimated PSF data is estimated based on an aberration component calculated from the measured PSF data.

6. The image recording device according to claim 5, wherein the aberration component is calculated by performing Fourier transform with respect to the measured PSF data.

7. The image recording device according to claim 3, wherein the estimating unit estimates the PSF data of the other areas based on an aberration component acquired from the measured PSF data and the design PSF data.

8. The image recording device according to claim 7, wherein the aberration component is calculated by performing Fourier transform with respect to the measured PSF data and the design PSF data.

9. A manufacturing apparatus of an image recording device comprising:
a capturing unit that causes an image recording device to capture an adjustment chart for virtually dividing an image sensor provided in the image recording device into a plurality of areas; and
an input unit that inputs measured PSF data indicating a PSF of the areas acquired from captured data of the adjustment chart captured by the image recording device to a memory provided in the image recording device so that the measured PSF data is held therein.

10. The manufacturing apparatus of an image recording device according to claim 9, wherein the input unit inputs design PSF data indicating a PSF acquired from a design value of an imaging lens provided in the image recording device to the memory so that the design PSF data is held therein.

11. The manufacturing apparatus of an image recording device according to claim 9, wherein
the measured PSF data indicates a PSF of a representative area of the areas,
the manufacturing apparatus further comprises an estimating unit that acquires estimated PSF data indicating a PSF of areas other than the representative area based on the measured PSF data, and
the input unit inputs the estimated PSF data to the memory provided in the image recording device so that the estimated PSF data is held therein.

12. The manufacturing apparatus of an image recording device according to claim 9, wherein
the manufacturing apparatus further comprises a selecting unit that selects one or two areas from the plurality of areas, and
the input unit inputs measured PSF data indicating a PSF of the one or two areas to the memory so that the measured PSF data is held therein.

13. The manufacturing apparatus of an image recording device according to claim 12, wherein the selecting unit selects the one or two areas based on captured data of the adjustment chart captured by the image recording device and a design value of the imaging lens provided in the image recording device.

14. The manufacturing apparatus of an image recording device according to claim 13, wherein an aberration component calculated from the measured PSF data acquired from the captured data is compared with an aberration component calculated from the design PSF data indicating a PSF acquired from a design value of the imaging lens to calculate a change rate, thereby selecting the one or two areas based on the change rate.

15. A manufacturing method of an image recording device comprising an imaging lens that takes light from a subject and an image sensor that converts light from the subject to a signal charge to acquire image data, the manufacturing method comprising:
assembling the image recording device by adjusting a distance between the imaging lens and the image sensor;
causing the image recording device to capture an adjustment chart for virtually dividing the image sensor into a plurality of areas; and
holding including inputting measured PSF data indicating a PSF of the areas acquired from captured data of the adjustment chart captured by the image recording device to a memory provided in the image recording device, and holding the measured PSF data therein.

16. The manufacturing method of an image recording device according to claim 15, wherein design PSF data indicating a PSF acquired from a design value of the imaging lens is input to and held in the memory.

17. The manufacturing method of an image recording device according to claim 15, wherein
the measured PSF data indicates a PSF of a representative area of the areas,
estimated PSF data indicating a PSF of areas other than the representative area is estimated based on the measured PSF data, and
the estimated PSF data is input to and held in the memory provided in the image recording device.

18. The manufacturing method of an image recording device according to claim 15, wherein
one or two areas are selected from the plurality of areas, and
the PSF data input and held in the memory is measured PSF data indicating a PSF of the one or two areas.

19. The manufacturing method of an image recording device according to claim 15, wherein the one or two areas are selected based on captured data of the adjustment chart captured by the image recording device and a design value of the imaging lens.

20. The manufacturing method of an image recording device according to claim 19, wherein the one or two areas are selected based on a change rate calculated by comparing an aberration component calculated from the measured PSF data acquired from the captured data with an aberration component calculated from the design PSF data indicating a PSF acquired from a design value of the imaging lens.
